(19) United States
(12) Patent Application Publication
(10) Pub. No.: US 2005/0155468 A1
(43) Pub. Date: Jul. 21, 2005

(54) Swing head structure of a wrench with two kinds of torque output

(76) Inventor: Te-Chen Chu, Da Li City (TW)

Correspondence Address: CHARLES E. BAXLEY, ESQ., 90 JOHN STREET, THIRD FLOOR, NEW YORK, NY, 10038, US

(21) Appl. No.: 10/759,872

(22) Filed: Jan. 16, 2004

(51) Int. Cl. B25B 23/16

(52) U.S. Cl. 81/177.8

(57) ABSTRACT

A swing head structure of a wrench with two kinds of torque output mainly comprises a head part and a handle, by a shaft pivot to adjust swing angles and positioning of the head part, the wrench can also be used as a ratchet wrench or can rotate the handle backwards and forwards to make the head part to rotate in one direction speedily, the rotating direction can be changed, the swinging movement of the head part does not affect the rotation and transmission of the wrench and the handle, the swinging head part having two kinds of torque output to the wrench.

### BACKGROUND OF THE INVENTION

A swing head structure of a wrench with two kinds of torque output mainly comprises a head part and a handle, by a shaft pivot to adjust swing angles and positioning of the head part, the wrench can also be used as a ratchet wrench or can rotate the handle backwards and forwards to make the head part to rotate in one direction speedily, the rotating direction can be changed, the swinging movement of the head part does not affect the rotation and transmission of the wrench and the handle, the swinging head part having two kinds of torque output to the wrench.

The U.S. Pat. No. 6,311,583 and Taiwan patent with publication no. 553808 of “A Ratchet Wrench”, both having a head part which can rotate pivotally in corresponding to the handle part, but their functions is too simple and with much complicated structure.

### SUMMARY OF THE INVENTION

The mainly purpose of the present invention is to provide a swing head structure of a wrench with two kinds of torque output. The wrench comprises a head part and a handle, the handle can be made as a combination of a long shaft and a handle part, the head part comprises a sleeve socket, a ratchet head and a switching-control part. The head part can be swung in different angles and positioned by a shaft pivot. The wrench can be used as a general ratchet wrench or can rotate the handle forward and backward to make the head part to rotate in one direction speedily, the rotating direction can be changed by switch-control mechanism. The swinging movement of the head part does not affect the rotation and transmission of the wrench and the handle. The swinging head part also having two kinds of torque output to the wrench.

The present invention will become more fully understood by reference to the following detailed description thereof when read in conjunction with the attached drawings.

### BRIEF DESCRIPTION OF THE DRAWINGS

FIG. 1 is perspective exploded view of a swing head structure of a wrench with two kinds of torque output;

FIG. 2 is a sectional assembly view of a swing head structure of a wrench with two kinds of torque output;

FIG. 3 is a sectional view of a swing head structure of a wrench with two kinds of torque output in swing movement;

FIG. 4 is a perspective view a swing head structure of a wrench with two kinds of torque output being used;

FIG. 5 is a perspective view of a swing head structure of a wrench with two kinds of torque output in speedy rotation;

FIG. 6 is a perspective view of a swing head structure of a wrench with two kinds of torque output in swing head movement;

FIG. 7 is a perspective exploded view of a ratchet of the present invention;

FIG. 8 is a perspective exploded view of a ratchet of the present invention of another embodiment;

FIG. 9 is perspective exploded view of a swing head structure of a wrench with two kinds of torque output of a second embodiment;

FIG. 10 is perspective exploded view of a swing head structure of a wrench with two kinds of torque output of a third embodiment.

### DETAILED DESCRIPTION OF THE PREFERRED EMBODIMENT

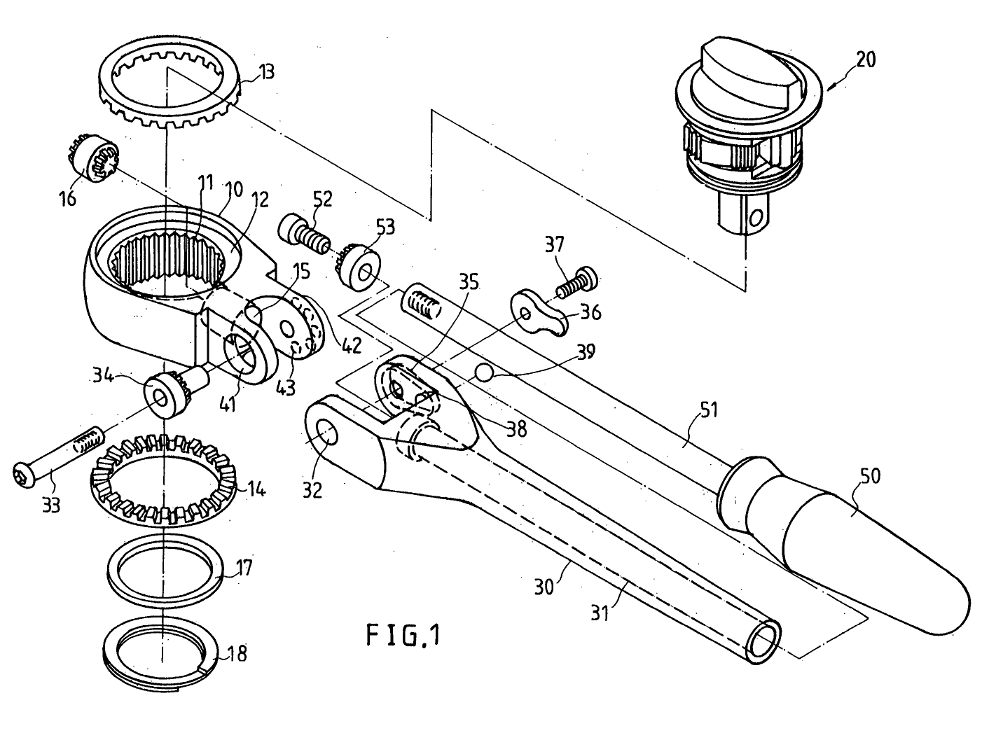

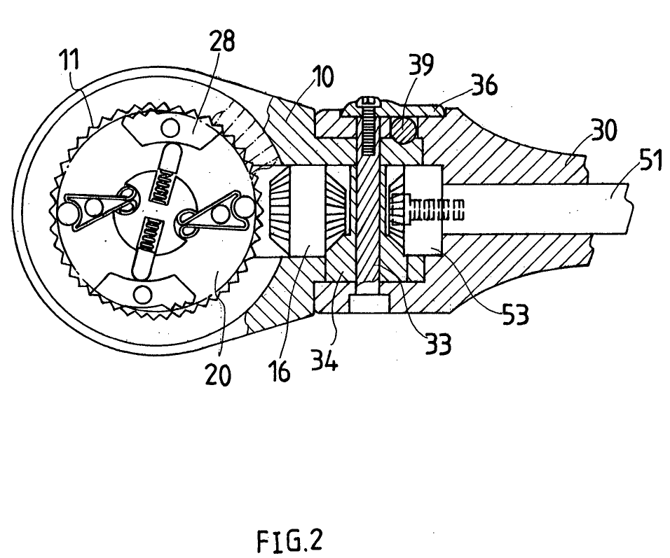

Referring to FIGS. 1 and 2, the present invention of a swing head structure of a wrench with two kinds of torque output, which mainly comprises a sleeve socket 10, with ratchet teeth 11 disposed on its inner circumference, its upper and bottom sides having a trough 12 for placing ring-shaped gears 13 and 14 respectively. The sleeve socket 10 having a placing part 15 on its one side along its axis direction for placing a transmission gear 16, the teeth shape of the transmission gear 16 can mesh with the ring-shaped gears 13 and 14.

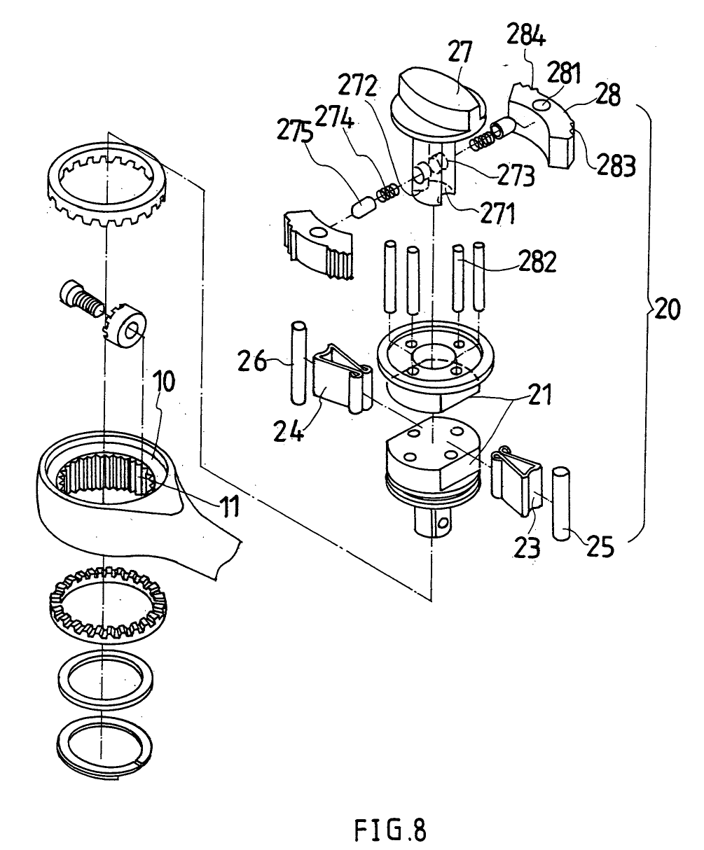

Referring to FIG. 8, the present invention also comprises a ratchet head 20, which having a dual-surfaces 21 for assembling bent elastic pieces 23 and 24, as well as circular rods 25 and 26 respectively. The fronts of the bent elastic pieces 23 and 24 are being bent in such a way that can limit and position the circular rods 25 and 26, while the back sections of the bent elastic pieces 23 and 24 are pressed against curved troughs 271 and 272 of a control switch 27 respectively. The other side of the control switch 27 having a hole 273 for placing pressing elements of a spring 274 and a pressing piece 275. Two curved pressing pieces 28 each having a central hole 281 is for inserting a rod 282 for positioning purpose. When the curved pressing pieces 28 are being pressed by the pressing elements 274 and 275 to one side, ratchet gears 283 and 284 of the curved pressing pieces 28 are being pressed against the ratchet teeth 11 of the sleeve socket 10, so that idling is achieved in order to change rotating direction.

A long shaft 30 having a long hollow hole 31 disposed along its axial direction, and a protruded ear 301 disposed on its front part, a hole 32 is disposed on the ear 301 for inserting a bolt 33 and a medium gear 34. The sleeve socket 10 having a protruded ear 40 and a hole 41 is disposed on it, accordingly, the bolt 33 goes through the hole 41 of the sleeve socket 10, thus the sleeve socket 10 can pivotally swing on it. A trough 35 is disposed on one side of the hole 32 of the long shaft 30, a switch-control 36 is placed inside the trough 35 and by using a screw 37 to lock with the bolt 33, the trough 35 having a ball hole 38 disposed inside for placing a steel ball 39 which is connected to a concave dot 43 disposed on a concave surface 42 of the protruded ear 40. When the switch-control 36 is not pressed against the steel ball 39, the sleeve socket 10 can rotate and swing freely. When the switch-control 36 is pressed against the steel ball 39, it is also pressed against the concave dot 43 of the protruded ear 40, so that the sleeve socket 10 can be positioned.

A handle 50 having long round shaft 51 to insert through the long hollow hole 31 of the long shaft 30. A screw 52 is used to lock a transmission gear 53 onto the front part of the round shaft 51.

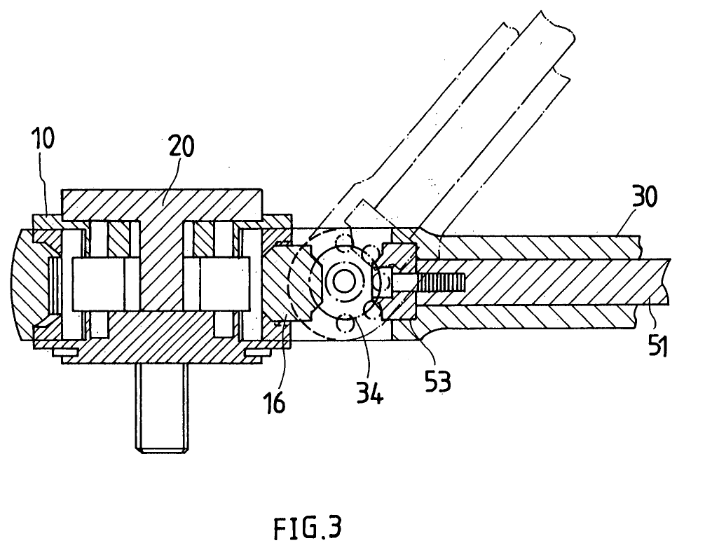

Referring to FIGS. 1, 2, 3 and 8, when assembling, the curved pressing pieces 28 is positioned by the rod 282, and the spring 274 and the pressing piece 275 are inserted into the hole 273 of the control switch 27 to press against on the curved pressing piece 28. Curved elastic pieces 23 and 24 as well as circular rods 25 and 26 are also assembled on the ratchet head 20. The ring-shaped gear 13 and the ratchet head 20 are inserted into the sleeve socket 10. The ring-shaped gear 14 is also inserted into the sleeve socket 10 on the other side, then by using a pad ring 17 and a spring pad 18 to hook on a trough 29 of the ratchet head 20, so that the ratchet head 20 and related elements will fall apart from the sleeve socket 10. The round shaft 51 of the handle 50 goes through the long hollow hole 31 of the long shaft 30, and then use the screw 52 to lock the transmission gear 53 onto the front part of the round shaft 51. The sleeve socket 10 having a compartment 80 for placing the transmission gear 16 to mesh with the ring-shaped gears 13 and 14. Align the hole 32 of the long hollow shaft 30 with the hole 41 of the sleeve socket 10, then assemble the medium gear 34 and the bolt 33. The ball hole 38 of the long shaft 30 is for placing the steel ball 39, the switch-control 36 is used to press against on the steel ball 39, then use the screw 37 to bolt the switch-control 36 onto the bolt 33.

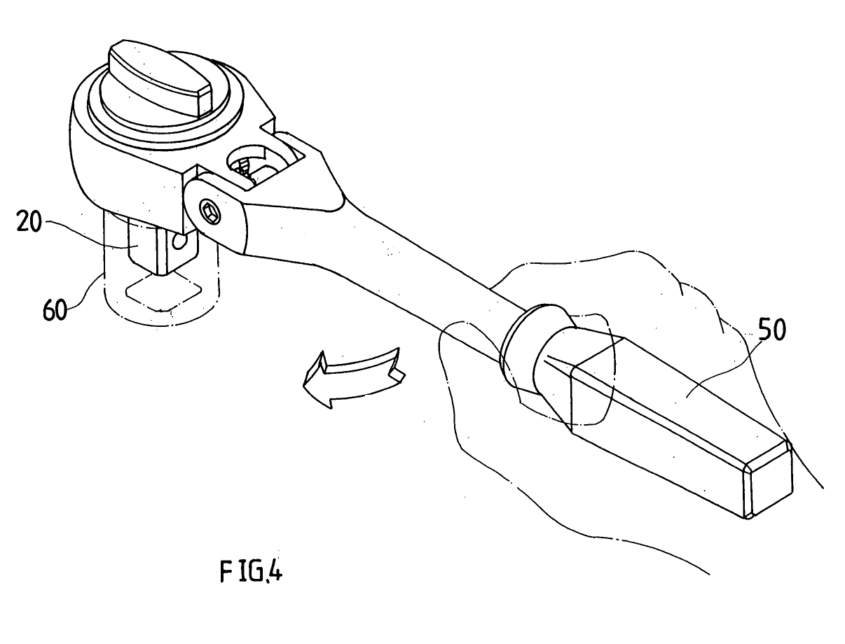

Referring to FIG. 4, the present invention being used as a wrench. It uses the ratchet head 20 having a sleeve part 60 which can be sleeved on a bolt. Hold the handle 50 and move it back and fro on the same level, the ratchet head 20 can be rotated to the opposite direction idly by having the curved pressing piece 28 mesh with the gear 11 (referring to FIG. 2). By turning the switch-control 27 to change the directions of both idling and transmission (referring to FIG. 8).

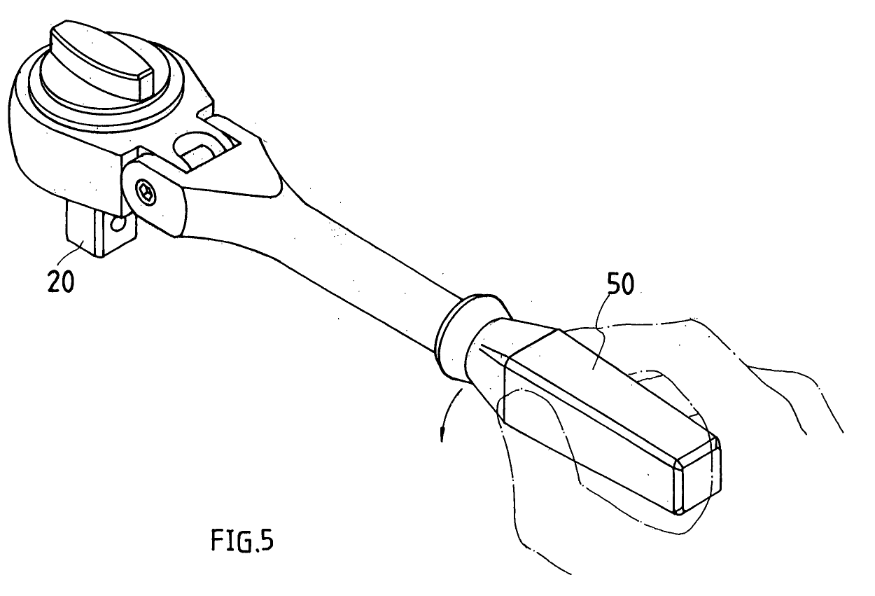

Referring to FIG. 5, which shows the operation by turning the handle 50 in dual-directions to make the ratchet head 20 to turn in single direction speedily. By quickly turning the handle 50 to transmit the rotating force to the medium gear 34 through the transmission gear 53 (referring to FIG. 2), then to the transmission gear 16 through the medium gear 34, the transmission gear 16 then make the ring-shaped gears 13 and 14 to rotate (referring to FIG. 1). If the rotating direction is the same as the circular rods 25 and 26, then the ratchet head 20 can be rotated. Vice versa, it turns idly. Because the rotating directions of the ring-shaped gears 13 and 14 are different, the back and fro rotation of the handle 50 allows one set of the ring-shaped gears 13 and 14 to make the ratchet head 20 to rotate continuously, so that one can speedily adjust rotation.

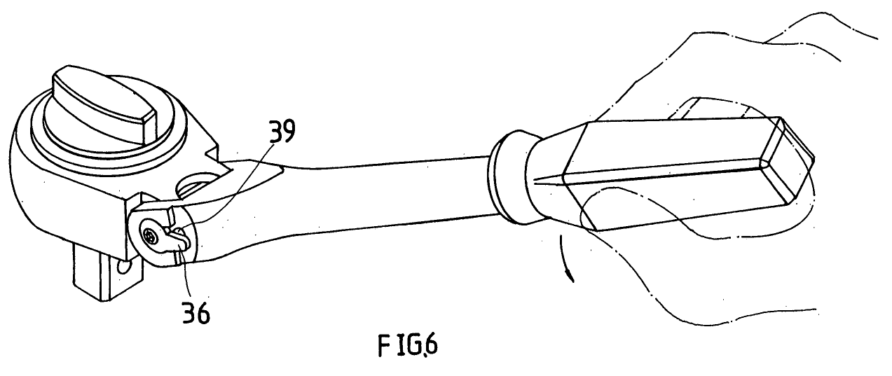

Referring to FIGS. 2, 3 and 6, if want to adjust the swing movement, turn the switch-control 36 so that it does not press against the steel ball 39, then the sleeve socket 10 can rotate on the bolt 33 as its axis, the transmission gear 16 will rotate together with the medium gear 34, until desired position is adjusted, turn the switch-control 36 to make the steel ball 39 to press against the concave dot 43 of the protruded ear 40 of the sleeve socket 10, so that the angle of the sleeve socket 10 can be fixed.

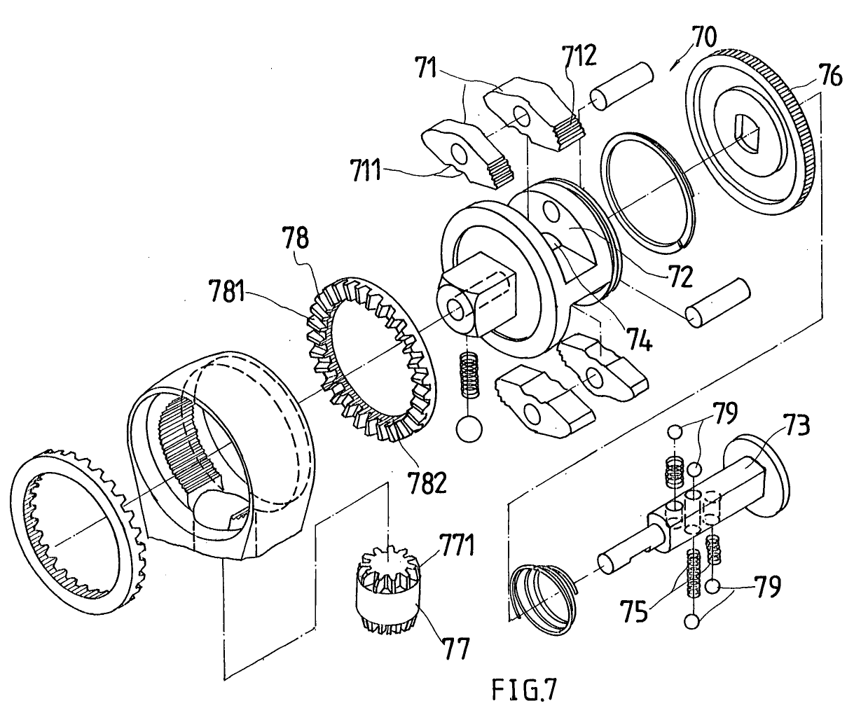

Referring to FIG. 7, a ratchet head 70 having two placing troughs 72 for placing two locking pieces 71 respectively, and a hole 74 for an initiate piece 73 to go through, the two locking pieces 71 each having a positioning trough 711 disposed on its inner end. The initiate piece 73 having a positioning steel ball 79 and an elastic element 75 in corresponding to the positioning trough 711. The initiate piece 73 is turned and adjusted by a wheel 76 to make the locking piece 71 to swing in an opposite direction. The two locking pieces 71 each having a ring-shaped gear wheel 78 sleeved outside. The two ring-shaped gear wheels 78 each having ratchet teeth 781, which can be meshed with an inclined wheel 771 disposed on top the a transmission shaft 77. The two ring-shaped gear wheels 78 each having an inner ratchet gear 782, while an outer ratchet gear 712 is disposed outside the two locking pieces 71.

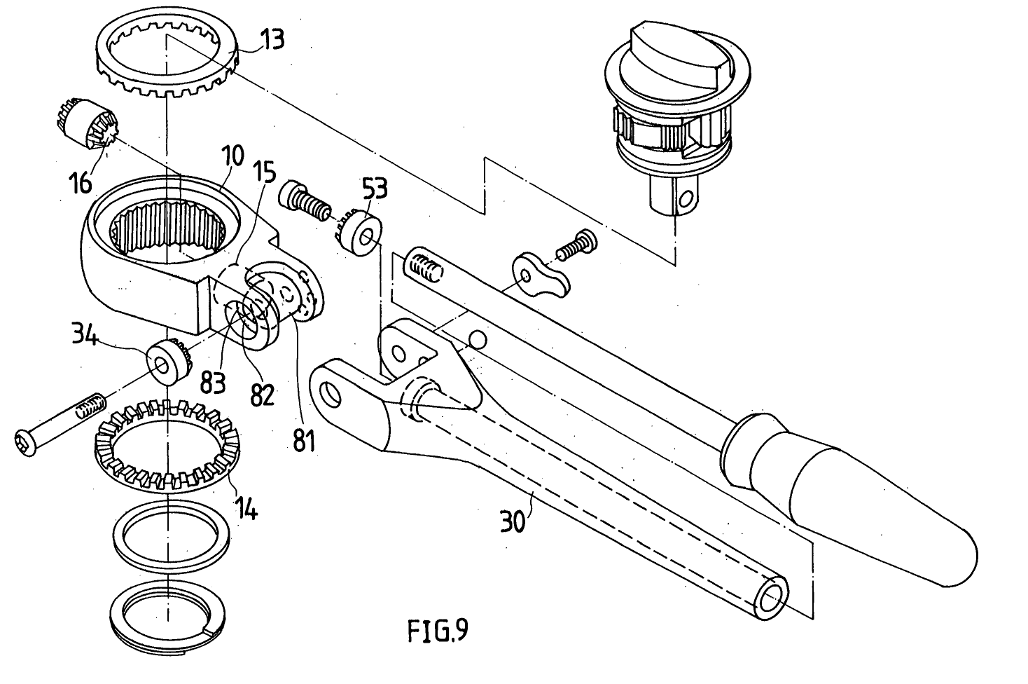

Referring to FIG. 9, a wrench having a sleeve socket 10 on its one end, and a long shaft 30 on the other end, a first compartment 15 is disposed inside the sleeve socket 10 for placing a transmission gear 16, a protruded piece 81 having a second compartment 82 for placing a medium gear wheel 34. A passage part 83 is formed between the first compartment 15 and the second compartment 82, which is for the sleeve socket 10 to pivotally connected to the long shaft 30 and is not entirely hollow inside, which can enforce the structure of the sleeve socket 10.

As for the swing head structure of the wrench, the sleeve socket 10 having the protruded piece 81, the second compartment 82 is disposed on the protruded piece 81 for placing the medium gear 34. The sleeve socket 10 having the transmission gear 16 disposed inside to transmit two ring-shaped gears 13 and 14 disposed inside the sleeve socket 10, the medium gear 34 of the second compartment 82 of the protruded piece 81 then transmit a transmission gear 53 of the handle structure and the transmission gear 16 of the sleeve socket 10.

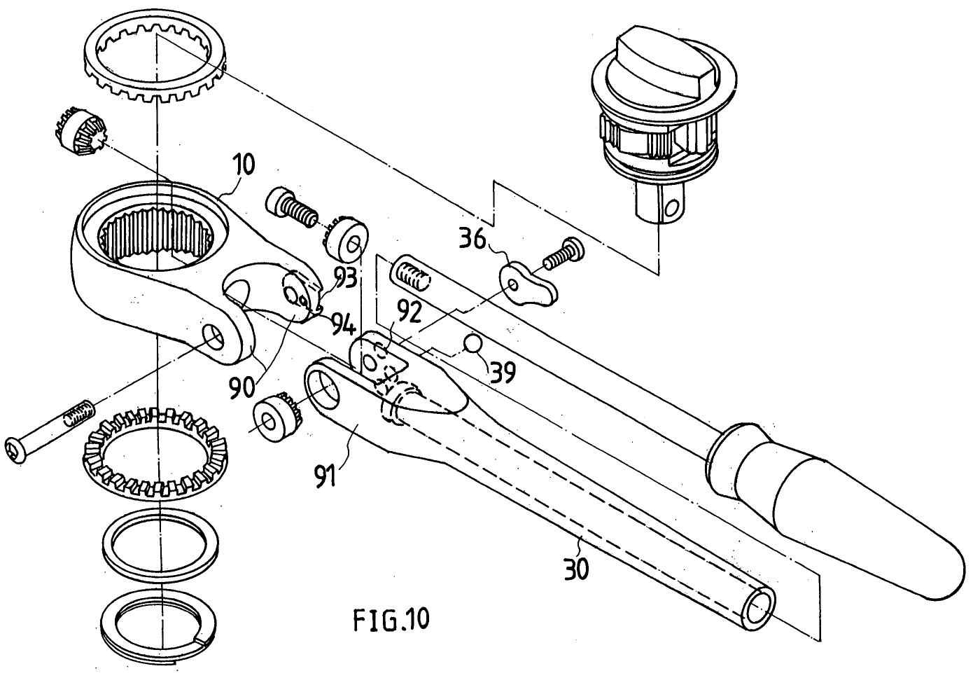

Referring to FIG. 10, a sleeve socket 10 having a protruded ear 90 for sleeving on a protruded ear 91 of the long shaft 30. A plurality of concave dots 92 are disposed on one side of the protruded ear 91 of the long shaft 30, a trough 93 is disposed on one side of the protruded ear 90 for placing a switch-control 36, a steel ball hole 94 is disposed on the protruded ear 90 for placing a steel ball 39, which can be controlled by the switch-control 36 and positioned on the concave dots 92.

Note that the specification relating to the above embodiment should be construed as exemplary rather than as limitative of the present invention, with many variations and modifications being readily attainable by a person of average skill in the art without departing from the spirit or scope thereof as defined by the appended claims and their legal equivalents.

1. A swing head structure of a wrench with two kinds of torque output mainly comprises;
a ratchet head structure which by its rotating mechanism and control, allows the wrench to rotate idly, change its rotating directions, or to make said ratchet head to rotate in one direction speedily by back and fro rotation of said wrench;
a swing head structure, which a sleeve socket having a protruded ear and a transmission gear disposed inside to transmit two ring-shaped gears disposed inside of said sleeve socket, said protruded ear having a medium gear disposed on its one side to transmit a gear of a handle structure and a gear of said sleeve socket;
a shaft structure, a protruded ear is disposed on its front part for sleeving on a protruded ear of said sleeve socket, said protruded ears can be pivotally rotated, a transmission gear is disposed inside said handle structure to mesh with said medium gear, said transmission gear is connected to a handle part, said handle part having a long shaft sleeved on its outer circumference, accordingly, said wrench can adjust swing angle and also features torque of conventional wrench, or can adjust swing angle and also can speedily rotate said handle part, its adjusted angle does not affect the two kinds torque output.

2. A swing head structure of a wrench with two kinds of torque output as claimed in claim 1, said protrudes ear of said sleeve socket having a plurality of concave dots disposed on its on side, a steel ball and a switch-control for controlling said steel ball are disposed on one side of said protruded ear of said handle in corresponding to said concave dots.

3. A swing head structure of a wrench with two kinds of torque output mainly comprises;
a ratchet head structure which by its rotating mechanism and control, allows the wrench to rotate idly, change its rotating directions, or to make said ratchet head to rotate in one direction speedily by back and fro rotation of said wrench;
a swing head structure, which a sleeve socket having a protruded ear for sleeving a protruded ear of a handle, and a transmission gear is disposed inside to transmit two ring-shaped gears also disposed inside of said sleeve socket, said protruded ear having a medium gear disposed on its one side to transmit a gear of a handle structure and a gear of said sleeve socket;
a shaft structure, a protruded ear is disposed on its front part, said protruded ears can be pivotally rotated, a transmission gear is disposed inside said shaft structure to mesh with said medium gear, said transmission gear is connected to a handle part, said handle part having a long shaft sleeved on its outer circumference, accordingly, said wrench can adjust swing angle and also features torque of conventional wrench, or can adjust swing angle and also can speedily rotate said handle part, its adjusted angle does not affect the two kinds torque output.

4. A swing head structure of a wrench with two kinds of torque output as claimed in claim 3, said protruded ear of said shaft structure having a plurality of concave dots, said protrudes ear of said sleeve socket having a steel ball and a switch-control for controlling said steel ball are disposed on its side in corresponding to said plurality of concave dots.

5. A swing head structure of a wrench with two kinds of torque output as claimed in claim 1 or 3, said sleeve socket of said swing head structure having a protruded piece which a second compartment is disposed on it for placing a medium gear, said sleeve socket having a transmission gear inside for transmitting two ring-shaped gears which are also disposed inside said sleeve socket, said medium gear inside said second compartment of said protruded piece transmits a gear of said shaft structure and a gear of said sleeve socket, said protruded ear disposed at the front end of said shaft structure is for sleeving onto said protruded piece of said sleeve socket, said protruded ears are bolted and can be pivotally rotated, a transmission gear is disposed inside said shaft structure to mesh with said medium gear, said transmission gear is connected to said handle part, said handle part having a long shaft sleeved on its outer circumference.

6. A swing head structure of a wrench with two kinds of torque output as claimed in claim 1 or 3, said ratchet head having two placing troughs for placing two locking pieces, and a hole for inserting an initiate piece, said locking pieces each having a positioning trough on its inner end, said initiate piece having a positioning ball and an elastic element in corresponding to said positioning trough, rotate and adjust said initiate piece by a wheel to make said locking pieces to swing in an opposite direction, said locking pieces each having a ring-shaped gear wheel disposed on its outer part, said ring-shaped gear wheels each having a ratchet teeth for meshing in opposite transmission directions with an inclined wheel disposed on top of a transmission shaft, said ring-shaped gear wheels each having an inner ratchet teeth, while said locking pieces each having an outer ratchet teeth on its outer end.

7. A swing head structure of a wrench with two kinds of torque output as claimed in claim 1 or 3, said ratchet head having a switch-control, two elastic elements and two steel balls and springs, said elastic elements can limit a circular rod, while said steel balls and springs are pressed against a piece with ratchet teeth, said ratchet head also having a ratchet teeth disposed on its side and ring-shaped gears disposed on its upper and bottom ends.
